(19) United States
(12) Patent Application Publication
(10) Pub. No.: US 2005/0165990 A1
(43) Pub. Date: Jul. 28, 2005

(54) Interrupt control device

(75) Inventors: Kazunori Kuki, Kasugai (JP); Masahiro Tanaka, Kasugai (JP); Hirokazu Kanma, Kasugai (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/084,010

(22) Filed: Mar. 21, 2005

Related U.S. Application Data
(63) Continuation of application No. PCT/JP03/00670, filed on Jan. 24, 2003.

(51) Int. Cl. G06F 13/24

(52) U.S. Cl. 710/260

(57) ABSTRACT

The interrupt control device is a Large Scale Integration (LSI) to which a wide variety of other devices, such as macros, can be connected. The interrupt control device includes a plurality of interrupt controllers that executes interrupt processing; a receiving unit that receives an interrupt signal from any one of the other devices; an interrupt number storing unit that stores an interrupt number assigned to a device from which the interrupt signal is received; and an outputting unit that outputs the interrupt signal to one of the interrupt controllers corresponding to the interrupt number stored.

### BACKGROUND OF THE INVENTION

1) Field of the Invention

The present invention relates to a Large Scale Integration (LSI) to which a wide variety of other devices can be connected.

2) Description of the Related Art

In recent years, not only information equipment such as personal computers and personal digital assistances, but also almost all generally-used electric appliances, such as AV equipment, cooking appliances, refrigerators, washing machines, and air conditioners, are controlled by central processing units (CPU).

Along with wider use of CPUs, intensive research and development of multi-functional, highly functional, and highly versatile system LSI, which can be mounted in various types of devices, are conducted.

If users, such as manufacturers of home appliances, can select any necessary function of such a chip as necessary, the chip need not be adapted to each product, enabling reduction of development costs and initial investment in factories.

However, attempt to increase the versatility of the chip inevitably increases the size and complexity of the circuit. In particular, since a great variety of macros are connected to the chip according to the product, a complex and large-scale circuit is needed just to control interrupts from these macros.

As shown in FIG. 7, when designing the hardware of a conventional system LSI, one interrupt number and one interrupt controller that executes processing identified by the number are exclusively provided for one interrupt factor (in concrete terms, macro).

For example, as shown in FIG. 7, when a certain event that requires an interrupt occurs in an interrupt factor 1, an interrupt signal created by the interrupt factor 1 is physically input only to one interrupt controller having an interrupt number of 15. When the signal is input to the controller, the controller executes interrupt processing of number 15 in compliance with its own interrupt conditions such as interrupt level and an interrupt vector address.

It is therefore essential in the conventional technique to provide interrupt mechanisms as much in number as the total number of interrupt factors expected to be connected to the system LSI, increasing the size and complexity of the circuit. Users of products in which the system LSIs are incorporated, such as home appliances, strongly demand miniaturization and price restrictions of the LSI by reducing the size of each component or the number of the components.

With respect to the above points, conventional techniques include one that stores a list of interrupt numbers in a rewriteable memory, specifies an address of the memory, and determines an interrupt vector address by using the interrupt number that is stored at that address. According to the conventional technique, while the interrupt vector address can be changed dynamically by rewriting the memory, other interrupt conditions cannot be changed (see, for example, Japanese Patent Application Laid-Open No. H10-11411).

### SUMMARY OF THE INVENTION

It is an object of the present invention to at least solve the problems in the conventional technology.

An interrupt control method according to an aspect of the present invention is an interrupt control method for an interrupt control device with a plurality of interrupt controllers. Each of the interrupt controllers executes interrupt processing for any one of other devices that is connected to the interrupt control device. The interrupt control method includes receiving an interrupt signal from any one of the other devices; and outputting the interrupt signal to one of the interrupt controllers corresponding to an interrupt number that is assigned to a device from which the interrupt signal is received, and that is stored in an interrupt number register.

An interrupt control device according to another aspect of the present invention is an interrupt control device to which a plurality of other devices is connected. The interrupt control device includes a plurality of interrupt controllers that executes interrupt processing; a receiving unit that receives an interrupt signal from any one of the other devices; an interrupt number storing unit that stores an interrupt number assigned to a device from which the interrupt signal is received; and an outputting unit that outputs the interrupt signal to one of the interrupt controllers corresponding to the interrupt number stored.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an explanatory diagram of the relationship between a combination of interrupt factors, interrupt conditions, and interrupt numbers in an appliance A incorporating an interrupt control device according to a first embodiment of the present invention;

FIG. 2 is a schematic explanatory diagram of the hardware configuration of the interrupt control device;

FIG. 3 is a flowchart of a sequence of interrupt control processing in the interrupt control device;

FIG. 4 is a schematic explanatory diagram of the hardware configuration of an interrupt control device according to a second embodiment of the present invention;

FIG. 5 is a list of interrupt numbers that can be respectively set in interrupt number setting circuits 402a to 402l;

FIG. 6 is a schematic explanatory diagram of the hardware configuration of an interrupt control device according to a third embodiment of the present invention; and

FIG. 7 is a schematic explanatory diagram of the hardware configuration of a conventional interrupt control device.

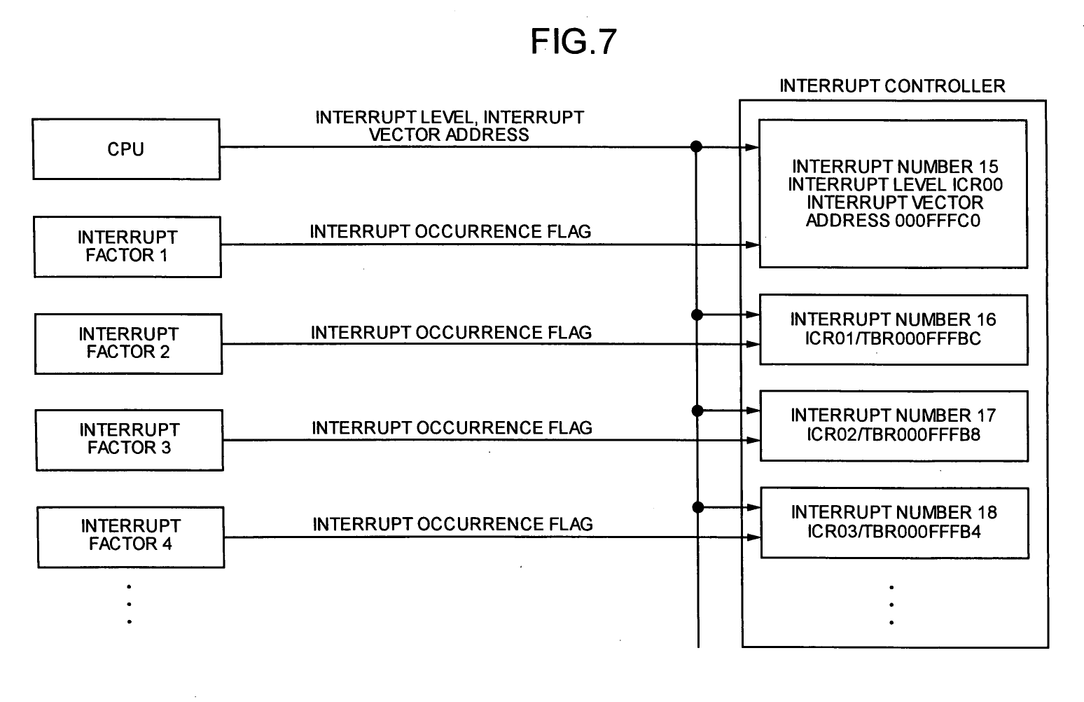

### DETAILED DESCRIPTION

Exemplary embodiments of the present invention will be explained in detail with reference to the accompanying drawings.

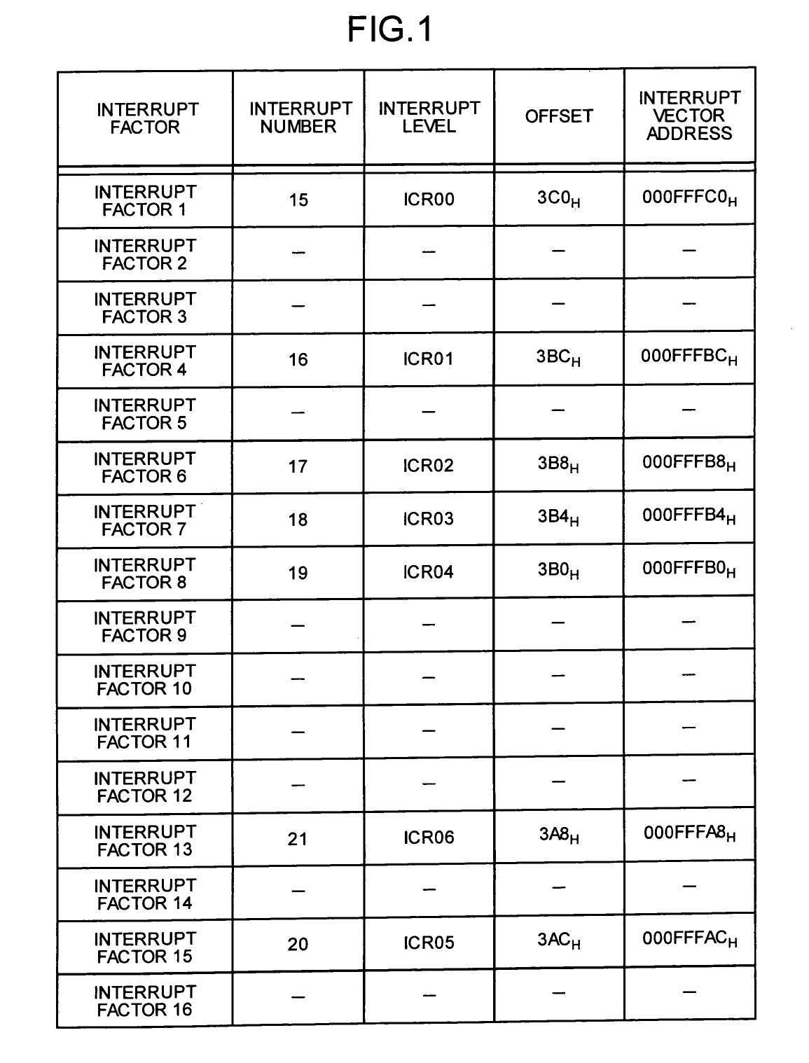

FIG. 1 is an explanatory diagram of the relationship between a combination of interrupt factors, interrupt conditions, and interrupt numbers in an appliance A incorporating an interrupt control device (specifically, a system LSI) according to a first embodiment of the present invention. The interrupt number is allocated to each of the interrupt factors, respectively.

As shown in FIG. 1, it is assumed that there are only seven interrupts arising from interrupt factors 1, 4, 6, 7, 8, 13, and 15 in the appliance A, and interrupt numbers of 15, 16, 17, 18, 19, 20, and 21 are allocated to the factors, respectively. Another appliance B has a combination of interrupt factors, a priority level of interrupts of the factors, and the like, which are different from those of appliance A shown in FIG. 1.

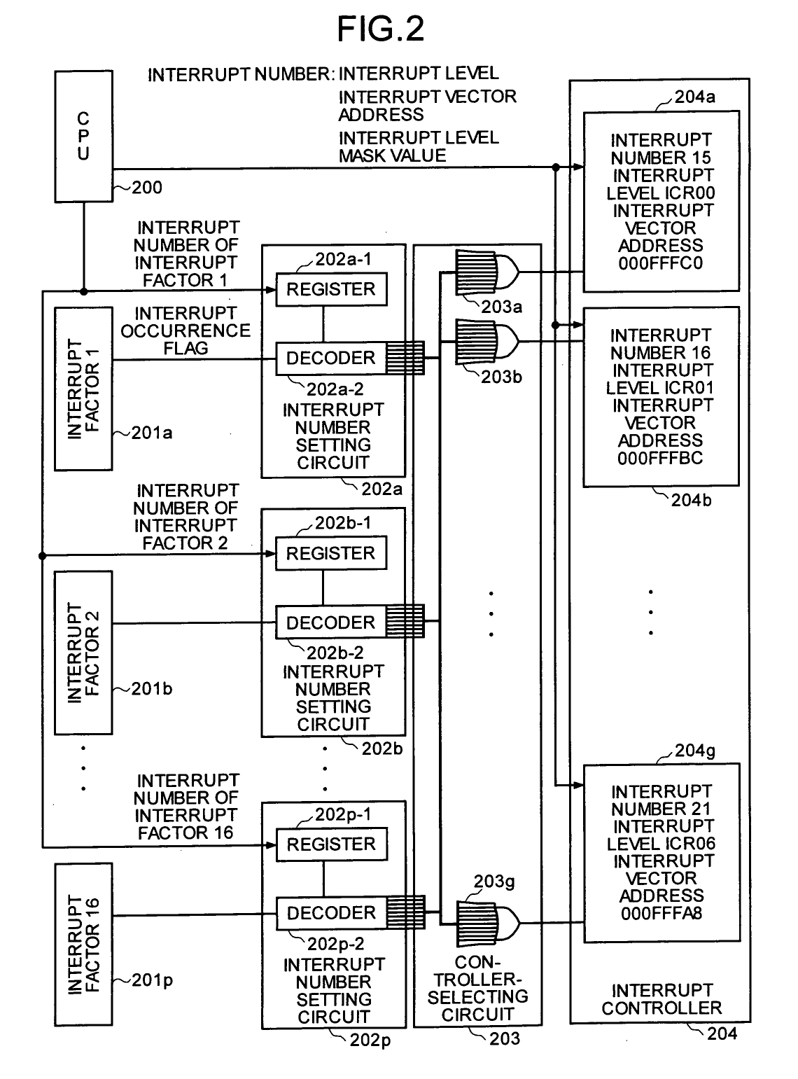

FIG. 2 is a schematic explanatory diagram of the hardware configuration of the interrupt control device according to the first embodiment of the present invention. FIG. 2 depicts the sections that are relevant to the present invention in various types of circuits in a system LSI that forms the interrupt control device of the present invention.

In FIG. 2, a CPU 200 sets an interrupt number for each register in interrupt number setting circuits 202a to 202p described below, and also sets various information needed in interrupt processing, such as interrupt levels and interrupt vector addresses in interrupt controllers 204a to 204g described below.

Interrupt factors 201a to 201p are macros and the like that execute specific processing. When an event occurs that requires an interrupt, a predetermined interrupt signal (interrupt occurrence flag) is output to interrupt number setting circuits 202a to 202p described below.

The number of interrupt number setting circuits 202a to 202p is equal to the number of interrupt factors. In this example, there are sixteen, one for each interrupt factor. Taking interrupt number setting circuit 202a as an example, this circuit is physically connected to the interrupt factor 1, and, when an interrupt occurs in the factor, is input an interrupt signal indicating the fact.

The interrupt number setting circuit 202a includes a register 202a-1 and a decoder 202a-2. An interrupt number is allocated beforehand to the interrupt factor 1, and set in the register 202a-1 by the CPU 200. In the example shown in FIG. 1, interrupt number 15 is set in the register 202a-1. The decoder 202a-2 is a circuit that outputs a signal to one of a plurality of bus lines in compliance with the value of the register 202a-1.

A controller-selecting circuit 203 includes OR circuits 203a to 203g, one for each interrupt number, seven in the example shown in FIG. 2. The OR circuits 203a to 203g in the controller-selecting circuit 203 output signals, which are output from the decoders 202a-2 to 202p-2 of the interrupt number setting circuits 202a to 202p, to one of the interrupt controllers 204a to 204g.

A set of interrupt controllers 204 that includes interrupt controllers 204a to 204g, one for each interrupt number, seven in the example shown in FIG. 2. In the explanation below, the set of interrupt controllers 204 is also termed “interrupt controller” unless there is a need to differentiate.

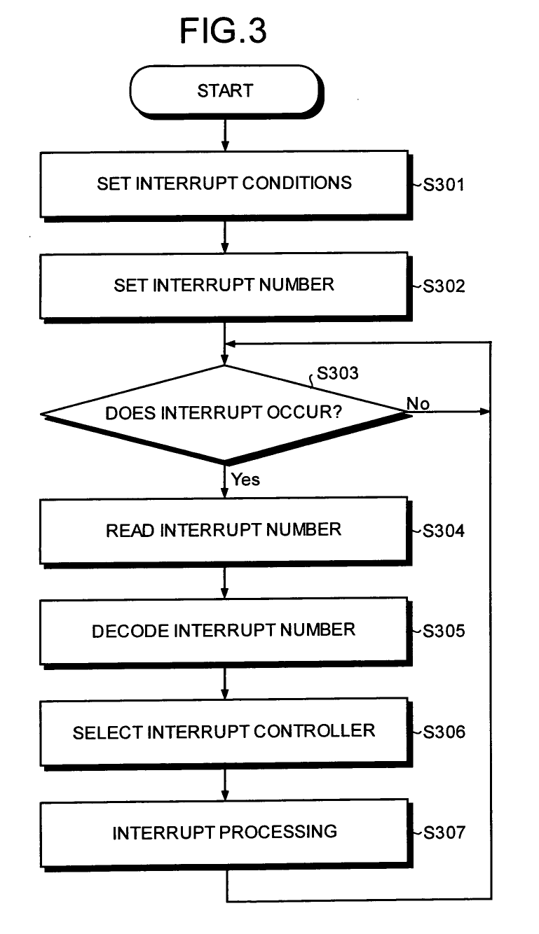

FIG. 3 is a flowchart of a sequence of interrupt control processing in the interrupt control device according to the first embodiment of the present invention. The CPU 200 that executes a predetermined program for setting interrupt information sets interrupt conditions specified by interrupt numbers 15 to 21 (e.g., interrupt level, interrupt vector address, interrupt level mask value, etc.) for each of the interrupt controllers 204a to 204g (step S301).

The CPU 200 then sets interrupt numbers, which are allocated to the corresponding interrupt factors 201a to 201p, in the registers 202a-1 to 202p-1 of the interrupt number setting circuits 202a to 202p (step S302). For example, an interrupt number 15, which is allocated to the interrupt factor 201a, is set in the register 202a-1, and a predetermined value indicating that no interrupt number is allocated is set in the register 202b-1. Steps S301 and S302 can be executed in reverse order.

When an interrupt signal from the interrupt factor 201a is input to the interrupt number setting circuit 202a (step S303: Yes), the allocated interrupt number is read from the register 202a-1 to the decoder 202a-2 (step S304).

The decoder 202a-2 decodes the number, i.e., the signal is output to one of the bus lines from the decoder 202a-2 (step S305). Of the OR circuits 203a to 203g, to which the signal is input, only the OR circuit 203a outputs 1, whereby an interrupt signal is input to the interrupt controller 204a that is connected to the circuit (step S306).

The interrupt controller 204a then executes the program at the interrupt vector address in accordance with a priority level and the like that is set thereto (step S307). When the program ends, processing returns to step S303 where the device waits for a new interrupt.

According to the first embodiment described above, it is possible to change the combination of interrupts, and the interrupt numbers and interrupt conditions that correspond to the interrupts, by controlling which interrupt number is set in which register of the interrupt number setting circuits 202a to 202p. The interrupt control device can be incorporated in various devices simply by changing the interrupt number settings and the like.

Since there is no wasteful interrupt controller that are not used in the products in which the device is incorporated, circuit size and power consumption can be reduced.

In the interrupt control device according to the first embodiment, the number of output lines from the decoders 202a-2 to 202p-2 of the interrupt number setting circuits 202a to 202p, and the number of input lines to the OR circuits 203a to 203g of the controller-selecting circuit 203, must be the same as the number of interrupt factors 201a to 201p.

Consequently, when attempting to deal with many interrupt factors to increase the versatility of the device, there is a problem of increasing the size and complexity of the circuit between the interrupt number setting circuits 202a to 202p and the interrupt controllers 204a to 204g. Accordingly, the circuit can be simplified by restricting to some extent the interrupt number settings, as in a second embodiment explained below.

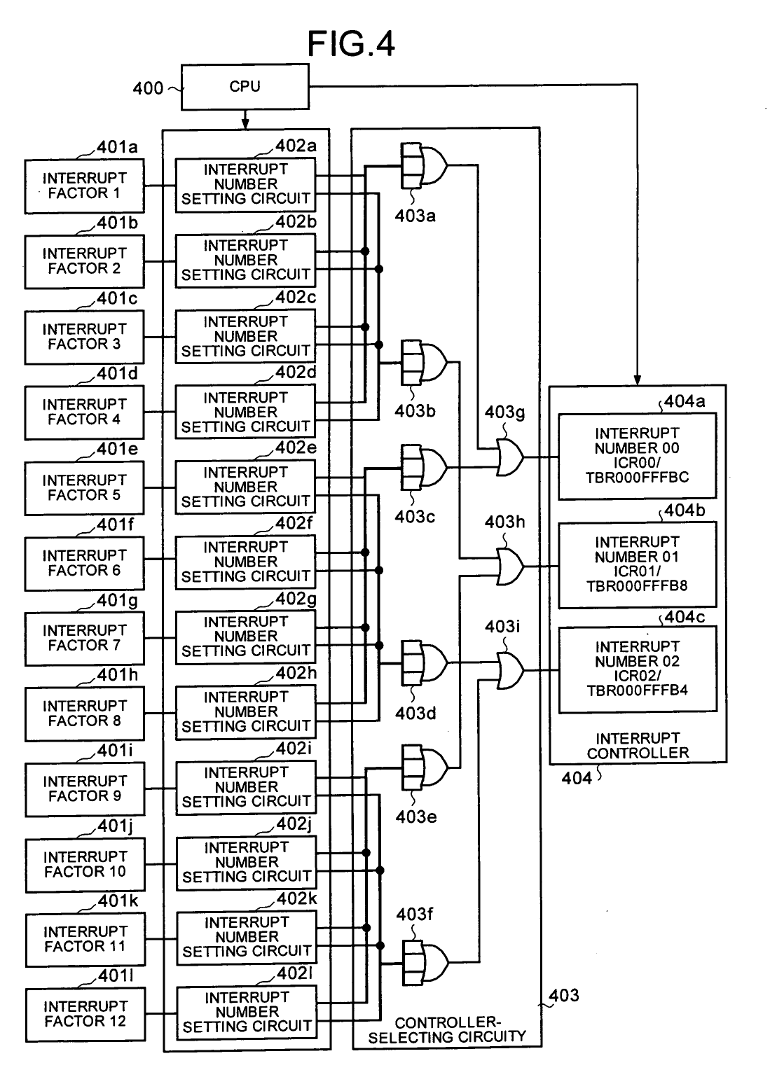

FIG. 4 is a schematic explanatory diagram of the hardware configuration of an interrupt control device according to the second embodiment of the present invention. In the interrupt control device according to the second embodiment, three interrupt numbers (as opposed to seven in the first embodiment) are allocated to twelve interrupt factors (sixteen in the first embodiment).

In the first embodiment shown in FIG. 2, while the interrupt number setting circuits 202a to 202p are each connected to the seven OR circuits 203a to 203g, interrupt number setting circuits 402a to 402l of the second embodiment are each connected to only two OR circuits.

For example, a signal output from the interrupt number setting circuit 402a that corresponds to an interrupt factor 401a is input only to an OR circuit 403a or 403b of preliminary stage OR circuits 403a to 403f. The signal then passes through a latter stage OR circuit 403g or 403h and is input only to an interrupt controller 404a or 404b of the three interrupt controllers. Therefore, of the three predetermined interrupt processes, only a process having number 0 or 1 can be activated.

In other words, the interconnections are such that, even when interrupt numbers other than “00” or “01” are set in the register of the interrupt number setting circuit 402a, the process corresponding to the number cannot be executed in this hardware. That is, the interrupt numbers that can be set in the interrupt number setting circuit 402a are restricted to “00” and “01”.

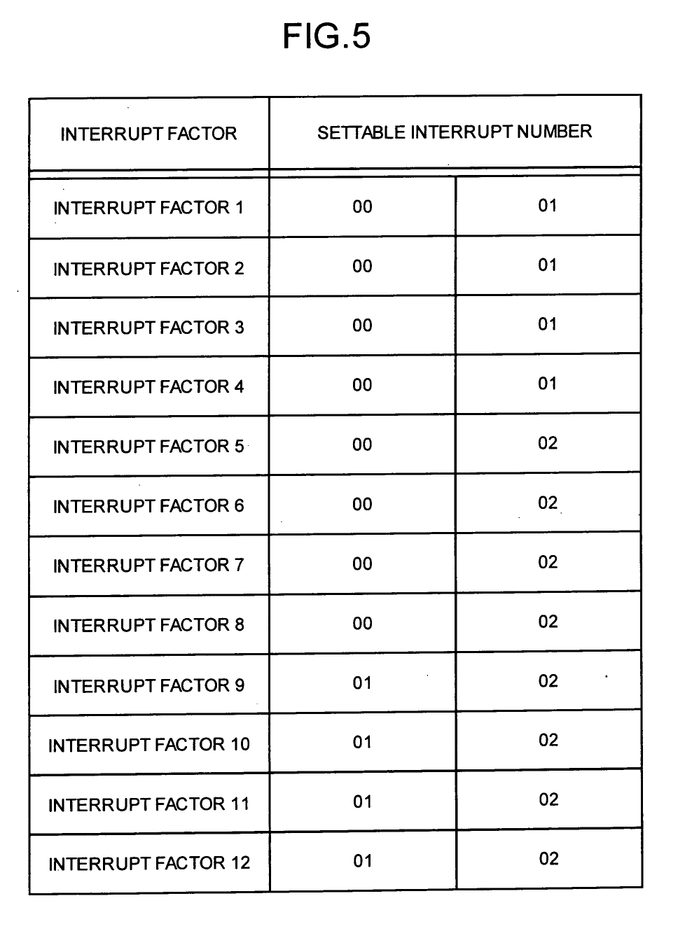

FIG. 5 is a list of interrupt numbers that can be respectively set in the interrupt number setting circuits 402a to 402l according to the second embodiment. As shown in FIG. 5, there are restrictions on the interrupt numbers that can be set in each circuit. For example, an interrupt number of “02” cannot be set in the interrupt number setting circuit 402a.

While the second embodiment imposes some restrictions on the interrupt numbers that can be set, there is an advantage that interconnections in a controller-selecting circuit 403 can be greatly simplified. Broader advantages can be obtained as the number of interrupt factors increases.

In the first and the second embodiments, all the interrupts from a variety of macros connected to the interrupt control device are permitted. However, it is sometimes desirable to inhibit interrupts from a particular macro.

According to a third embodiment, a predetermined value that represents an interrupt inhibit can be set in the register of an interrupt setting circuit, so that the corresponding interrupt factor does not output the interrupt signal when this value is set.

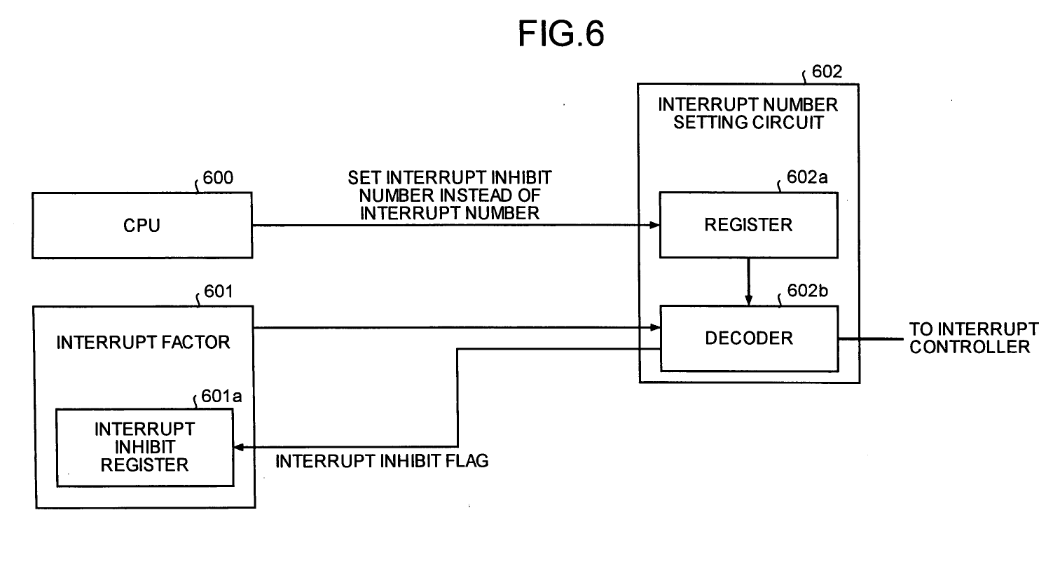

While the hardware configuration of an interrupt control device according to the third embodiment of the present invention is approximately the same as that of the first embodiment shown in FIG. 2 or the second embodiment shown in FIG. 4, the interconnections around the interrupt number setting circuits are slightly different. FIG. 6 is a schematic explanatory diagram of the hardware configuration of the interrupt control device according to the third embodiment, for mainly explaining these differences.

As shown in the diagram, one data line from a decoder 602b in an interrupt number setting circuit 602 connects to an interrupt inhibit register 601a in an interrupt factor 601. When a CPU 600 sets a predetermined value that indicates interrupt inhibit (hereinafter, “interrupt inhibit number”) in a register 602a, the value on the data line from the decoder 602b that decodes the value becomes 1, and this signal is input to the interrupt inhibit register 601a.

An interrupt inhibit flag is set in the interrupt inhibit register 601a that receives the signal, and the interrupt factor 601 does not output an interrupt signal while the flag is set. The inhibit flag of the interrupt inhibit register 601a is cancelled when the CPU 600 rewrites the register 602a and sets an interrupt number instead of an interrupt inhibit number.

According to the third embodiment, an interrupt from an interrupt factor corresponding to the interrupt number setting circuit 602 can be inhibited by setting an interrupt inhibit number, instead of an interrupt number, in the circuit.

Since conventional techniques inhibit interrupts by setting the interrupt level to 0, the interrupt signal itself is transmitted from the interrupt factor to the interrupt controller. According to the present invention, since no interrupt signal is generated, the circuit is not occupied with an inhibited interrupt, making processing efficient.

According to the present invention, a user who incorporates the system LSI according to the present invention in home appliances and the like can arbitrarily switch which interrupt is used, which processing is executed when an interrupt occurs, and the like, merely by changing interrupt numbers and interrupt inhibit numbers that are set in the register for each interrupt factor. This is ideal for an interrupt control method and an interrupt control device that can control a wide variety of interrupts required by the user while limiting the circuit size, especially in a system LSI having superior versatility and cost performance.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An interrupt control method for an interrupt control device with a plurality of interrupt controllers, each of which executes interrupt processing for any one of other devices that is connected to the interrupt control device, comprising:
receiving an interrupt signal from any one of the other devices; and
outputting the interrupt signal to one of the interrupt controllers corresponding to an interrupt number that is assigned to a device from which the interrupt signal is received, and that is stored in an interrupt number register.

2. The interrupt control method according to claim 1, wherein the interrupt number storing unit is provided corresponding to each of the other devices.

3. The interrupt control method according to claim 1, wherein the outputting includes outputting the interrupt signal to one interrupt controller of a specific group of the interrupt controllers corresponding to the interrupt number stored.

4. The interrupt control method according to claim 1, further comprising:
notifying that an interrupt is inhibited to any one of the other devices for which an inhibition flag is stored in an inhibition flag register.

5. The interrupt control method according to claim 4, wherein the inhibition flag storing resistor is provided corresponding to each of the other devices.

6. The interrupt control method according to claim 5, wherein the interrupt number register and the inhibition flag register are included in one register.

7. An interrupt control device to which a plurality of other devices is connected, comprising:
a plurality of interrupt controllers that executes interrupt processing;
a receiving unit that receives an interrupt signal from any one of the other devices;
an interrupt number storing unit that stores an interrupt number assigned to a device from which the interrupt signal is received; and
an outputting unit that outputs the interrupt signal to one of the interrupt controllers corresponding to the interrupt number stored.

8. The interrupt control device according to claim 7, wherein the interrupt number storing unit is provided corresponding to each of the other devices.

9. The interrupt control device according to claim 7, wherein the outputting unit includes a decoder and a plurality of bus lines, wherein the decoder outputs the interrupt signal to one of the bus lines corresponding to the interrupt number stored.

10. The interrupt control device according to claim 9, wherein the outputting unit includes a plurality of OR circuits for outputting the interrupt signal to the interrupt controller corresponding to the interrupt number stored.

11. The interrupt control device according to claim 10, wherein the outputting unit outputs the interrupt signal to one interrupt controller of a specific group of the interrupt controllers corresponding to the interrupt number stored.

12. The interrupt control device according to claim 7, further comprising:
an inhibition flag storing unit that stores an inhibition flag for inhibiting an interrupt from any one of the other devices; and
a notifying unit that notifies a device that the interrupt is inhibited.

13. The interrupt control device according to claim 12, wherein the inhibition flag storing unit is provided corresponding to each of the other devices.

14. The interrupt control device according to claim 13, wherein the interrupt number storing unit and the inhibition flag storing unit are included in one register.
